(19) United States
(12) Patent Application Publication
(10) Pub. No.: US 2007/0061808 A1
(43) Pub. Date: Mar. 15, 2007

(54) Scheduler for a network processor

(76) Inventors: Sanjay Kumar, Bangalore (IN); Manoj Paul, Bangalore (IN)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/228,591

(22) Filed: Sep. 15, 2005

(51) Int. Cl. G06F 9/46

(52) U.S. Cl. 718/102

(57) ABSTRACT

According to an aspect of the present invention, a scheduler schedules a thread, supporting the execution of a microblock, to process a packet based on the status of the thread and presence of a valid message corresponding to the thread. The microblock and the thread may be selected based on a corresponding scheduling policy. Such an approach may result in an efficient use of processor cycles and the bandwidth of the internal bus.

### BACKGROUND

A computer network generally refers to a group of interconnected wired and/or wireless devices such as, for example, laptops, mobile phones, servers, fax machines, printers, etc. Computer networks often transfer data in the form of packets from one device to another device(s). An intermediate network device may consume processing cycles and such other computational resources while transferring packets.

### BRIEF DESCRIPTION OF THE DRAWINGS

The invention described herein is illustrated by way of example and not by way of limitation in the accompanying figures. For simplicity and clarity of illustration, elements illustrated in the figures are not necessarily drawn to scale. For example, the dimensions of some elements may be exaggerated relative to other elements for clarity. Further, where considered appropriate, reference labels have been repeated among the figures to indicate corresponding or analogous elements.

FIG. 1 illustrates an embodiment of a network environment.

FIG. 2 illustrates an embodiment of a network device of FIG. 1

FIG. 3 illustrates an embodiment of a network processor of the network device of FIG. 2.

FIG. 4 illustrates the details of an operation of the network processor of FIG. 3.

### DETAILED DESCRIPTION

The following description describes a system and an intermediate network device supporting a scheduler. In the following description, numerous specific details such as logic implementations, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits, and full software instruction sequences have not been shown in detail in order not to obscure the invention. Those of ordinary skill in the art, with the included descriptions, will be able to implement appropriate functionality without undue experimentation.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Embodiments of the invention may be implemented in hardware, firmware, software, or any combination thereof. Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc.

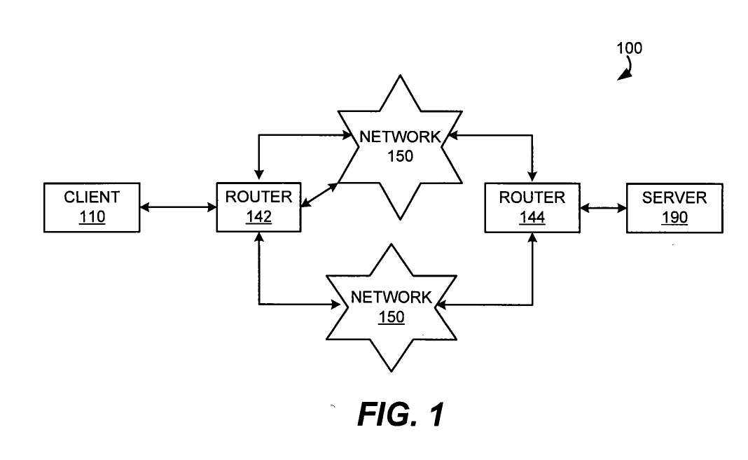

An embodiment of a network environment 100 is illustrated in FIG. 1. The network environment 100 may comprise a client 110, a router 142 and a router 144, a network 150, and a server 190. For illustration, the network environment 100 is shown comprising a small number of each type of device; however, a typical network environment may comprise a large number of each type of device.

The client 110 may comprise a desktop computer system, a laptop computer system, a personal digital assistant, a mobile phone, or any such computing system. The client 110 may generate one or more packets and send the packets to the network 150. The client 110 may receive packets from the network 150 and process the packets before sending the packets to a corresponding application. The client 110 may be connected to an intermediate network device such as the router 142 via a local area network (LAN) to send and receive the packets. The client 110 may, for example, support protocols such as hyper text transfer protocol (HTTP), file transfer protocols (FTP), TCP/IP.

The server 190 may comprise a computer system capable of sending the packets to the network 150 and receiving the packets from the network 150. The server 190 may generate a response packet after receiving a request from the client 110. The server 190 may send the response packet corresponding to the client 110 via the routers 144 and 142 and the network 150. The server 190 may comprise, for example, a web server, a transaction server, a database server, and such other servers.

The network 150 may comprise one or more network devices such as a switch or a router, which may receive the packets, process the packets, and send the packets to an appropriate intermediate network device or an end network device. The network 150 may enable transfer of packets between the client 110 and the server 190. The network devices of the network 150 may be configured to support various protocols such as TCP/IP.

The routers 142 and 144 may enable transfer of packets between the client 110 and the server 190 via the network 150. For example, the router 142 after receiving a packet from the client 110 may determine the next router provisioned in the path and may forward the packet to the next router in the path. Also, a packet received from the network 150 may be forwarded to the client 110. The router 142 may determine the next router based on the entries in the routing table. The entries may comprise an address prefix and corresponding port identifiers.

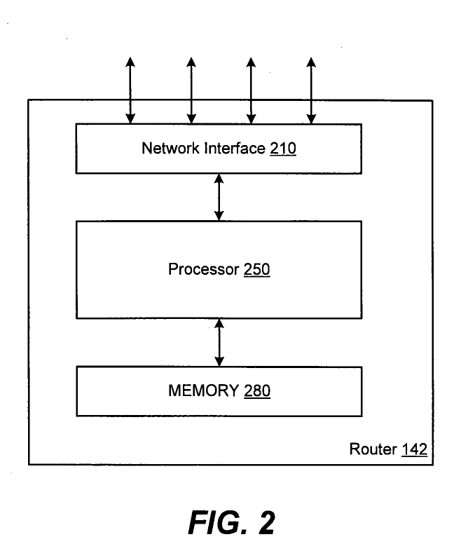

An embodiment of the router 142 is illustrated in FIG. 2. The router 142 may comprise a network interface 210, a processor 250, and a memory 280. The router 142 may receive one or more packets from client 110 and may determine, for example, the output ports on which the packets may be forwarded to the adjacent devices. However, several aspects of the present invention may be implemented in the router 144 or another intermediate network device of the network 150.

The network interface 210 may transfer one or more packets between the client 110 and the network 150. For example, the network interface 210 may receive the packets from the client 110 and send the packet to the processor 250 for further processing. The network interface 210 may provide physical, electrical, and protocol interfaces to transfer packets between the client 110 and the network 150.

The memory 280 may store one or more packets and packet related information that may be used by the processor 250 to process the packets. In one embodiment, the memory 280 may store packets, look-up tables, data structures that enable the processor 250 to process the packets. In one embodiment, the memory 280 may comprise a dynamic random access memory (DRAM) and a static random access memory (SRAM).

The processor 250 may receive one or more packets from the network interface 210, process the packets, and send the packets to the network interface 210. In one embodiment, the processor 250 may comprise, for example, Intel® IXP2400 network processor. In one embodiment, the processor 250 may receive a packet, perform header processing, determine the output port, and send the packet to the network interface 210. In one embodiment, the processor 250 may comprise a scheduler to schedule the processor resources such as microengine threads. Such an approach may cause efficient utilization of the processor resources.

In one embodiment, the processor 250 may receive the packets and schedule the resources such that the packets may be processed and forwarded on an appropriate output port quickly to perform the packet processing at the line rate. The processor 250 may schedule the resources such as microengine threads based on the availability of the threads and the sub-task. Such an approach may cause the processor 250 to efficiently utilize the resources such as processing cycles and bandwidth of one or more internal buses.

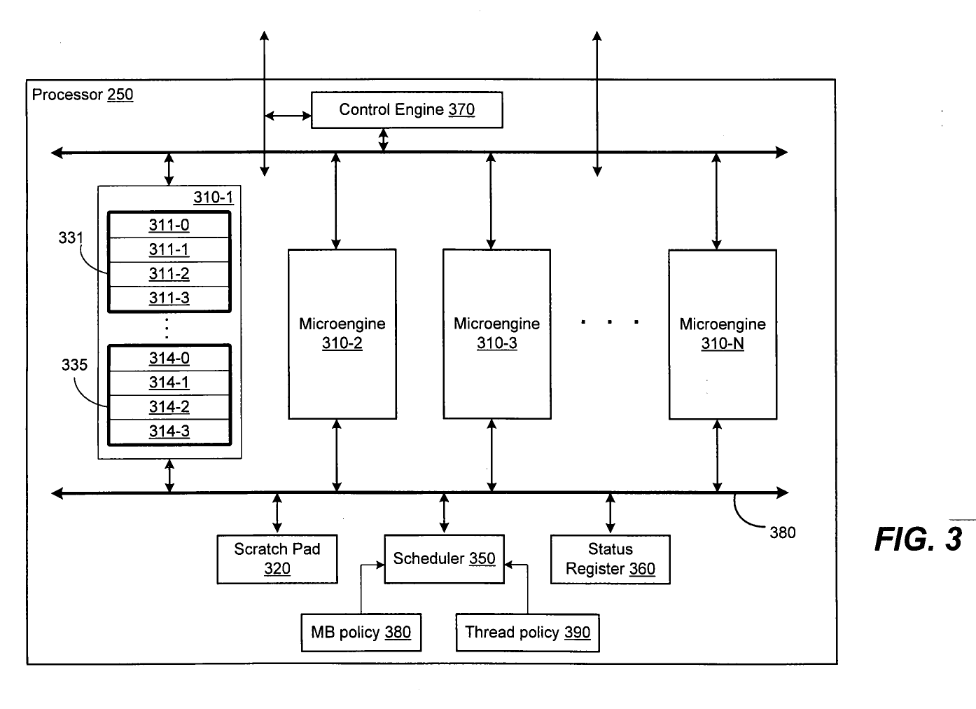

An embodiment of the processor 250 is illustrated in FIG. 3. The processor 250 may comprise microengines 310-1 through 310-N, a scratch pad 320, a status register 360, a scheduler 350, a control engine 370, a scratch bus 380, MB policy 380, and thread policy 390. The scratch pad 320 may store, for example, a buffer handler and such other data exchanged between two microengines corresponding to each packet in a pre-specified memory location. In one embodiment, the scratch pad 320 may store packet information corresponding to a packet Px, in a memory location Lxyz, wherein x represents the packet identifier, y represents the sinking microengine, and z represents the sourcing microengine. For example, a memory location L012 may store packet meta-data corresponding to packet P0 sunk or written by the microengine 310-1 and sourced or read by the microengine 310-2.

In one embodiment, the packet processing on the microengines 310-1 through 310-N may be divided into one or more logical functions and each logical function may be referred to as a microblock. The threads of the microengine 310-1 through 310-N may support one or more microblocks.

The microengine 310-1 through 310-N may co-operatively operate to process the packets. Each microengine may process a portion of the packet processing task and the microengines may determine the output port and send the packet to the network interface 210. The processing of a packet may comprise sub-tasks such as packet validation, IP lookup, determining the type of service (TOS), time to live (TTL), out going address and the MAC address. In one embodiment, the microengines 310-1 through 310-N may comprise one or more threads and each thread may perform a sub-task. One or more threads of a microengine may execute a micro-block.

In one embodiment, the processor 250 may comprise eight microengines and each microengine in turn may comprise eight threads. For example, the microengine 310-1 may comprise threads such as 311-0 to 311-3 and 314-0 to 3144. The threads 311-0 to 311-3 may be assigned to execute a microblock 331 and threads 314-0 to 314-3 may be assigned to execute a microblock 335. The microblock 331 may, for example, determine the type of the packets by inspecting the packet header and the microblock 335 may perform packet validation.

In one embodiment, the thread 311-0 may receive a packet P0 and process the packet P0 to determine the type of packet. In the process, the thread 311-0 may initiate, for example, an I/O read operation. As the I/O read may take longer duration, the thread 311-0 may enter a wait state (‘sleep’ mode) during that period. While thread 311-0 is in wait state, the thread 311-1 may process a packet P1 and may then enter a wait state and the thread 311-2 may start processing a packet P2. However, the threads 311-0 and 311-1 may wake up and continue to respectively process the packets P0 and P1 after receiving a corresponding signal from the scheduler 350.

As a result of the scheduling, each of the threads 311-0 through 314-3 may wait for the signal from the scheduler 350 and may then perform a pre-determined task. However, the threads may not attempt to read the data from the scratch pad 320. As the threads may not attempt to read the contents of the scratch pad 320 a number of processing cycles may be saved that otherwise may be wasted in reading null values or invalid data before reading a valid data. Also, the traffic on the scratch bus 380, caused by reads checking for valid data, may be reduced. As a result the bandwidth of the scratch bus 380 may be conserved. Such an approach may enable the processor 250 to efficiently utilize the processor resources.

The microengines 310-1 through 310-N may use one or more pre-determined memory locations of the scratch pad 320 to source the information such as the packet meta-data to an adjacent microengine. The thread 311-0 of the microengine 310-1 may store the type of the packet P0 (e.g., IPV4) into a pre-determined memory location, for example, L012 of the scratch pad 320 after completing the sub-task.

A thread of the microengine 310-2 may read the data from the location L012 and perform the corresponding sub-task such as IP look-up to determine the output port for packet P0. The thread of the microengine 310-2 may store, for example, the output port of packet P0 into location L023 and the corresponding thread of the microengine 310-3 may read the data representing output port from the location L023 and send the packet P0 on the specified output port. In one embodiment, the packet meta-data may comprise data such as the length of the packet, type of the packet, an offset indicating the start bit identifying the payload, input port, output port, source address, destination address and such other data relevant for processing the packet.

The status register 360 may comprise one or more registers to store the status of the threads. For example, each thread 311-0 through 314-3 of the microengine 310-1 may set or reset a pre-specified bit in the status register 360 to indicate the status of the corresponding thread. The thread 311-0 may store 0 in bit-zero of the status register 360 to indicate that the thread 311-0 is busy while determining the type of the packet P0. The thread 311-0 may store logic 1 in bit-zero after entering the sleep mode, which may indicate that the thread 311-0 is ready to process the corresponding packet.

In one embodiment, the processor 250 may support eight microengines and each microengine may support eight threads. As a result the processor 250 may support 64 threads. The status register 360 may comprise, for example, two 32 bit registers. The bit-0 to bit-7 may respectively store the status of the eight threads of the microengine 310-1. Each thread of the microengine may update the status by setting or resetting the corresponding bit in the status register 360.

The control engine 370 may support the microengines 310-1 through 310-N by updating the control tables such as the look-up tables. In one embodiment, the control engine 370 may comprise, for example, Intel® XScale™ core. The control engine 370 may create one or more microblocks that process network packets. The control engine 370 may allocate the threads of the microengines for executing the microblocks.

In one embodiment, the control engine 370 may receive input values from a user and may initialize the data structures based on the user inputs. In one embodiment, the data structures may receive and maintain configuration information such as the number of microblocks that may be initialized in the processor 250. The data structures may specify the cluster of the microengines that may execute the microblock. For example, the microengines 310-1 through 310-N of the processor 250 may be divided into two clusters cluster-1 and cluster-2.

The data structures may specify the start thread and the end thread that may execute a microblock, the microengine that supports the allocated threads, and the cluster that comprises the microengine. For example, the control engine 370 may specify that threads 311-0 to 311-3 of microengine 310-1 of a cluster may execute the microblock 331. The control engine 370 may allow the user to provide configuration data using interfaces such as an application programmable interface (API).

The scheduler 350 may schedule the threads of the microengine based on the status of the thread and the validity of the message. In one embodiment, the scheduler 350 may be implemented as a piece of hardware. In other embodiments, the scheduler 350 may be implemented as a set of instructions a group of threads may execute to implement the scheduler 350 as a microblock. In another embodiment, the scheduler 350 may be implemented via hardware of the control engine 370 and/or instructions executed by the control engine 370.

In one embodiment, the scheduler 350 may select the microblock based on a microblock scheduling policy 380 such as a round-robin scheduling policy, a wait state scheduling policy, a priority scheduling policy, and/or some other scheduling policy. For example, the scheduler may schedule a system of four microblocks MB0, MB1, MB2, MB3 using a round-robin policy as follows MB0, MB1, MB2, MB3, MB0, MB1, MB2, MB3, and so on. In one embodiment, the scheduler 350 may utilize a predefined microblock scheduling policy 380. Other embodiments may enable a user to select a microblock scheduling policy 380 and/or enable the scheduler 350 to dynamically select a microblock scheduling policy 380.

Similarly, the scheduler 350 may select a thread of the microengine supporting the selected microblock to process a sub-task based on a thread scheduling policy 390 such as a round-robin scheduling policy, a wait state scheduling policy, a priority scheduling policy, and/or some other scheduling policy. For example, the scheduler may schedule two threads T0, T1 of a microblock 331 using a round-robin policy as follows T0, T1, T0, T1, T0, T1, and so on. In one embodiment, the scheduler 350 may utilize a predefined thread scheduling policy 390. Other embodiments may enable a user to select a thread scheduling policy 390 and/or enable the scheduler 350 to dynamically select a thread scheduling policy 390.

In one embodiment, the scheduler 350 may determine the status of the selected thread, determine the validity of the corresponding message, and schedule the selected thread to process the packet. The scheduler 350 may send a signal if the thread is ready (or free) and if the valid message is available for the corresponding thread. In one embodiment, the scheduler 350 may retrieve the bit value of the status register 360 that may correspond to the selected thread, determine the status of the selected thread based on the retrieved bit value. The scheduler 350 may check for the presence of a valid message at a specified location of the scratch pad 320 reserved for the selected thread.

As a result, the scheduler 350 may schedule the threads after determining the status of the thread and the validity of the message as compared to each thread consuming processing cycles and bandwidth of the scratch bus 380 to read the data from the corresponding memory location of the scratch pad 360 until receiving a valid message. Such an approach may cause efficient utilization of the processor resources by saving the processor cycles spent on reading the invalid data and the bandwidth of the scratch bus 380 may be conserved as well. Thus, the processor 250 may process the packets quickly, for example, at the line rate.

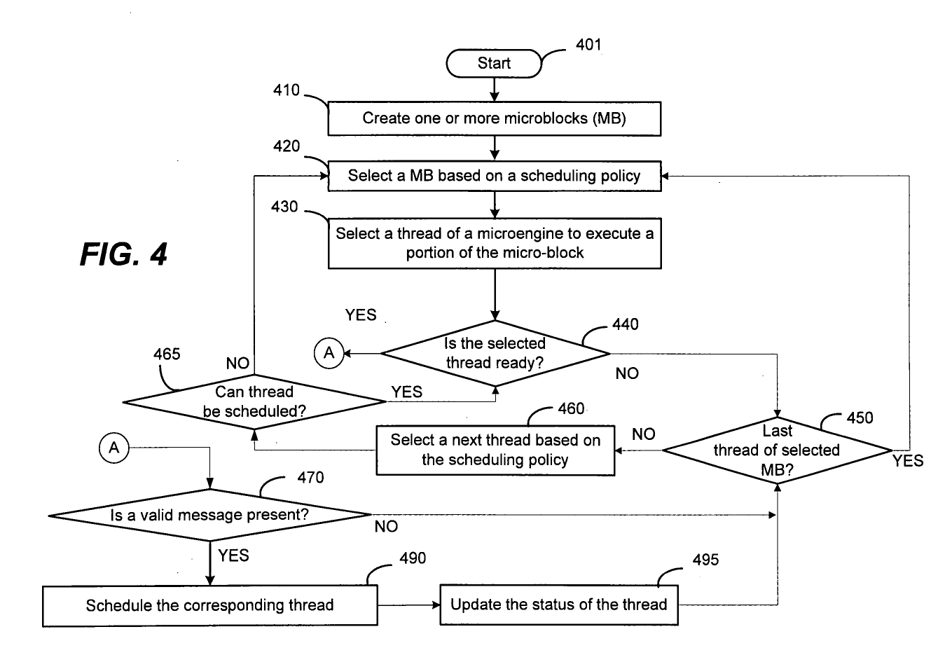

An embodiment of the operation of the processor 250 scheduling a microblock is illustrated in FIG. 4. In block 410, the control engine 370 may create one or more micro-blocks. The control engine 370 may create microblocks as described above. In block 420, the scheduler 350 may select the microblock for execution based on a scheduling policy such as a round-robin scheduling policy or priority scheduling policy. In block 430, the scheduler 350 may select a thread of a microengine to execute a portion of the micro-block. The scheduler 350 may select a thread based on a scheduling policy such as a round-robin scheduling policy.

In block 440, the scheduler 350 may determine if the selected thread is ready. The scheduler 350 may check the bit value stored in the corresponding bit position of the status register 360. In one embodiment, the scheduler 350 may check the value stored in bit-0 of the status register 360 and determine that the corresponding thread 311-0 is ready if the bit value equals 0 and busy otherwise. If the selected thread is not ready, the scheduler 350 in block 450 may determine whether the selected thread is the last thread of the selected microblock to be scheduled. If the scheduler 350 has attempted to schedule all threads of the microblock, then the schedule 350 may return to block 420 to select another microblock. Otherwise, the scheduler 350 in block 460 may select a next thread of the selected microblock. The scheduler 350 in block 465 may check whether the selected thread can be scheduled and may return to block 440 to determine if the newly selected thread is ready and to block 420 otherwise.

If the selected thread is ready, the scheduler 350 in block 470 may determine whether a valid message is present for the selected thread. In one embodiment, the scheduler 350 may determine that a valid message is present if the data corresponding to a handler indicates a non-null value such as the header type (e.g., IPV4 or IPV6), or the output port, or any such meta-data relevant to packet processing.

If a valid message is not present, the schedule may proceed to block 450 to determine whether the selected thread is the last thread of the microblock to be scheduled. Otherwise, the scheduler 350 in block 490 may schedule the selected thread to process the packet by sending a signal to the selected thread. Further, the scheduler 350 in block 495 may update the status of the selected thread from ready to busy and return to block 450 to determine whether the selected thread is the last thread of the microblock to be scheduled.

Certain features of the invention have been described with reference to example embodiments. However, the description is not intended to be construed in a limiting sense. Various modifications of the example embodiments, as well as other embodiments of the invention, which are apparent to persons skilled in the art to which the invention pertains are deemed to lie within the spirit and scope of the invention.

What is claimed is:

1. A network processor to process network packets, comprising
a plurality of microengines, each microengine comprising a plurality of threads that process network packets as a result of executing one or more microblocks,
a scratch pad to store messages for threads of the plurality of microengines,
one or more status registers to indicate whether each thread of the plurality of microengines is ready, and
a scheduler selects a thread and to cause the selected thread to be executed by its respective microengine in response to the status register indicating the selected thread is ready and in response to the scratch pad comprising a valid message for the selected thread.

2. The network processor of claim 1 further comprising a control engine to create the one or more microblocks that process network packets and to allocate threads of the plurality of microengines for executing the plurality of microblocks.

3. The network processor of claim 1 wherein one or more microblocks executed by the plurality of microengines implements the scheduler.

4. The network processor of claim 1 wherein the scheduler selects the thread by
selecting a microblock of the plurality of microblocks based upon a first scheduling policy, and
selecting a thread of the selected microblock based upon a second scheduling policy.

5. The network processor of claim 1 wherein the scheduler selects the thread by
selecting a microblock of the plurality of microblocks based upon a round robin scheduling policy, and
selecting a thread of the selected microblock based upon a round robin scheduling policy.

6. A method of processing network packets with a network processor comprising
storing messages for a plurality of threads of the network processor,
indicating whether each thread of the plurality of threads is busy, and
causing the network processor to execute a selected thread in response to determining that the selected thread is not busy and a valid message is stored for the selected thread.

7. The method of claim 6 further comprising
creating one or more microblocks to process network packets, and
allocating one or more threads of the plurality of threads to each of the one ore more microblocks.

8. The method of claim 6 further comprising creating one or more microblocks to determine that the selected thread is not busy and a valid message is stored for the selected thread.

9. The method of claim 6 further comprising
selecting, based upon a first scheduling policy, a microblock of a plurality of microblocks that each comprise one or more threads to process network packets, and
selecting a thread of the selected microblock based upon a second scheduling policy.

10. The method of claim 6 further comprising
selecting, based upon a round robin scheduling policy, a microblock of a plurality of microblocks that each comprise one or more threads to process network packets, and
selecting a thread of the selected microblock based upon a round robin scheduling policy.

11. A machine-readable medium comprising a plurality of instructions that in response to being executed result in a network processor
processing network packets with plurality of microblocks executed by plurality of threads,
storing messages for the plurality of threads and a status for each thread of the plurality of threads that indicate whether each thread is ready, and
selecting a thread to be executed in response to the status for the thread indicating the thread is ready and a valid message being stored for the thread.

12. The machine-readable medium of claim 11 further comprising
creating the plurality of microblocks to process network packets, and
allocating at least one thread of the plurality of threads to each microblock of the plurality of microblocks.

13. The machine-readable medium of claim 11 creating a microblock to select the thread to be executed in response to the status for the thread indicating the thread is ready and a valid message being stored for the thread.

14. The machine-readable medium of claim 11 wherein selecting the thread comprises
selecting a microblock of the plurality of microblocks based upon a first scheduling policy, and
selecting a thread of the selected microblock based upon a second scheduling policy.

15. The machine-readable medium of claim 11 wherein selecting the thread comprises
selecting a microblock of the plurality of microblocks based upon a round robin scheduling policy, and
selecting a thread of the selected microblock based upon a round robin scheduling policy.

16. A network device comprising
a network interface to transfer network packets, and
a network processor comprising a plurality of threads to process the network packets, wherein the network processor executes a thread of the plurality of threads in response to determining the thread is not busy and a valid message is awaiting the thread.

17. The network device of claim 16, wherein the network processor comprises a plurality of microengines, each microengine comprising at least one thread of the plurality of threads.

18. The network device of claim 16, wherein
the network processor comprises a plurality of clusters,
each cluster comprises at least one microengine, and
each microengine comprises at least one thread of the plurality of threads.

19. The network device of claim 16, wherein the network processor updates a status associated with each thread of the plurality of threads to indicate whether each thread is busy.

20. The network device of claim 16, wherein the network processor updates a status associated with each thread of the plurality of threads to indicate whether each thread is ready.
